(19) United States
(12) Patent Application Publication
(10) Pub. No.: US 2004/0027016 A1
(43) Pub. Date: Feb. 12, 2004

(54) Electric machine

(76) Inventors: Peter Bruder, Ottersweier (DE); Trudpert Meier, Buehl (DE); Markus Liedel, Pegnitz (DE); Thomas Helming, Baden-Baden (DE); Hermann Scherer, Rust (DE)

Correspondence Address: Striker Striker & Stenby, 103 East Neck Road, Huntington, NY, 11743, US

(21) Appl. No.: 10/362,609

(22) PCT Filed: Jun. 20, 2002
(86) PCT No.: PCT/DE02/02256

(30) Foreign Application Priority Data
Jun. 30, 2001 (DE) 101 31 761.1

(51) Int. Cl. H02K 5/00

(52) U.S. Cl. 310/89; 310/75 D

(57) ABSTRACT

An electrical machine according to the related art comprises a rotor shaft. The rotor shaft must be installed as a separate component.

An electrical machine (1) designed according to the invention is developed with a housing (4) and the arrangement of the bearing (49) in such a fashion that a rotor shaft does not have to be installed. As a result, the number of components to be installed is reduced, and the axial length of the electrical machine (1) is shortened.

### BACKGROUND OF THE INVENTION

The invention is based on an electrical machine according to the general description of claim 1 and/or 2.

An electrical commutator motor is made known in EP 0 125 502 A1 and/or U.S. Pat. No. 4,558,245 that comprises an outer housing with permanent magnets, whereby a rotor is supported on a rotor shaft interconnected with the housing and developed as a separate part. The use of a separate rotor shaft increases the number of parts of the commutator motor to be assembled.

### ADVANTAGES OF THE INVENTION

In contrast, the electrical machine according to the invention having the characterizing features of claim 1 and/or 2 has the advantage that the number of parts to be assembled and/or a size of the electrical machine is minimized in simple fashion. For example, only one bearing is used that lies in the center of gravity of the rotor, by way of which the bearing is optimally loaded. A fan wheel covers an open part of a housing of the electrical machine, so that a housing cover is not necessary.

Advantageous further developments and improvements of the electrical machine named in claim 1 and/or 2 are possible as a result of the measures listed in the dependent claims 3 through 30.

It is advantageous to form a basic structure out of plastic, because this is a favorable material, thereby making the basic structure easier to produce.

In order for the basic structure to comprise magnetic poles, permanent magnets can be arranged on the basic structure in advantageous fashion, e.g., they can comprise a plastic coating applied by injection molding; or, the basic structure is composed of a mixture of plastic and a material that is capable of being permanently magnetically excited.

The housing, at least part of which forms a magnetic yoke for the electrical machine, is advantageously composed of an outer wall and an inner wall that are interconnected by a base. In this manner, the housing can be easily produced as a single component.

A commutator for an electrical commutator machine advantageously comprises a commutator carrier, by means of which said commutator is secured to a laminated stack that is an integral part of a jacket of the laminated stack, for example, and is therefore capable of being produced in the same working step.

A bearing is advantageously secured to the housing by calking the bearing or the housing. Calking is a simple and inexpensive method for fastening two objects together.

It is advantageous to secure at least one electronic-electrical component to the housing, because this results in a compact size of the electrical machine.

The electronic-electrical component can advantageously have a plurality of functions, e.g., it can form a brush tube, and/or a brush holder, and/or it can comprise the closed-loop control electronics necessary for the electrical machine. The electronic-electrical component can be preassembled as a built-in component and it can be installed in the electrical machine in one working step. In this fashion, the electronic-electrical component can be individualized.

In order to produce a fan out of the electrical machine in advantageous fashion, a fan wheel is secured to the laminated stack or the basic structure. It is advantageous when the laminated stack advantageously comprises a plastic coating applied by injection molding, so that the fan wheel is produced at the same time as the plastic coating is applied to the laminated stack by injection molding.

The electrical machine has a bent brush tube in which bent brushes are located, by way of which space can be spared in advantageous fashion.

The brush holder can form part of the housing of the electrical machine, so that the part of the housing that forms the magnetic yoke is advantageously easier to produce.

The brush holder, which is located on the electronic-electrical component and is produced by means of injection molding of plastic, for example, can also hold the permanent magnets in the vicinity of the housing in advantageous fashion, e.g., by applying a plastic coating to them by injection molding when the brush holder is produced. The permanent magnets therefore do not need to be fixed at the housing with springs, for example.

The brush holder is advantageously designed so that it also forms the bearing for the electrical machine. This eliminates the need to install a separate bearing.

### SUMMARY OF THE DRAWINGS

Exemplary embodiments of the invention are shown in simplified form in the drawings and will be described in greater detail in the description hereinbelow.

FIGS. 1a through 1c are sectional drawings of parts of an electrical machine developed according to the invention that are produced in initial working steps for an electrical machine developed according to the invention.

FIGS. 2a through 2e show further production steps for parts shown in sectional drawings for an electrical machine developed according to the invention.

FIGS. 3a through 3d are sectional drawings showing the final assembly of an electrical machine developed according to the invention.

FIG. 4 is a subsection of a sectional drawing showing an electrical machine developed according to the invention having a laminated stack comprising a coating applied by injection molding.

FIG. 5 is a subsection of a sectional drawing of an electrical machine developed according to the invention having a radial commutator.

FIG. 6 is a subsection of a sectional drawing of an electrical machine developed according to the invention with the option of using long carbon brushes.

FIG. 7a shows bent brushes for use in an electrical machine developed according to the invention. FIG. 7b is a sectional drawing showing the arrangement of bent brushes inside an electrical machine developed according to the invention.

FIG. 8 is a subsection of a sectional drawing of an electrical machine developed according to the invention, whereby the housing is composed of a magnetic yoke and a plastic part.

FIG. 9 is a subsection of a sectional drawing showing the use of a plastic bearing for an electrical machine developed according to the invention.

FIGS. 10a through 10d are subsections of a sectional drawing showing various possibilities for installing a fan wheel on the electrical machine developed according to the invention.

FIG. 11 is a sectional drawing showing the fastening of an electrical machine developed according to the invention to a mounting ring that is developed as an outer rotor.

FIG. 12 is a sectional drawing of a further possibility for locating a bearing in an electrical machine developed according to the invention.

FIG. 13 is a sectional drawing of an electrical machine developed according to the invention having a basic structure that comprises magnetic poles, and

FIG. 14 is a sectional drawing showing the flow path of a coolant inside the electrical machine developed according to the invention.

### DESCRIPTION OF THE PREFERRED EMBODIMENTS

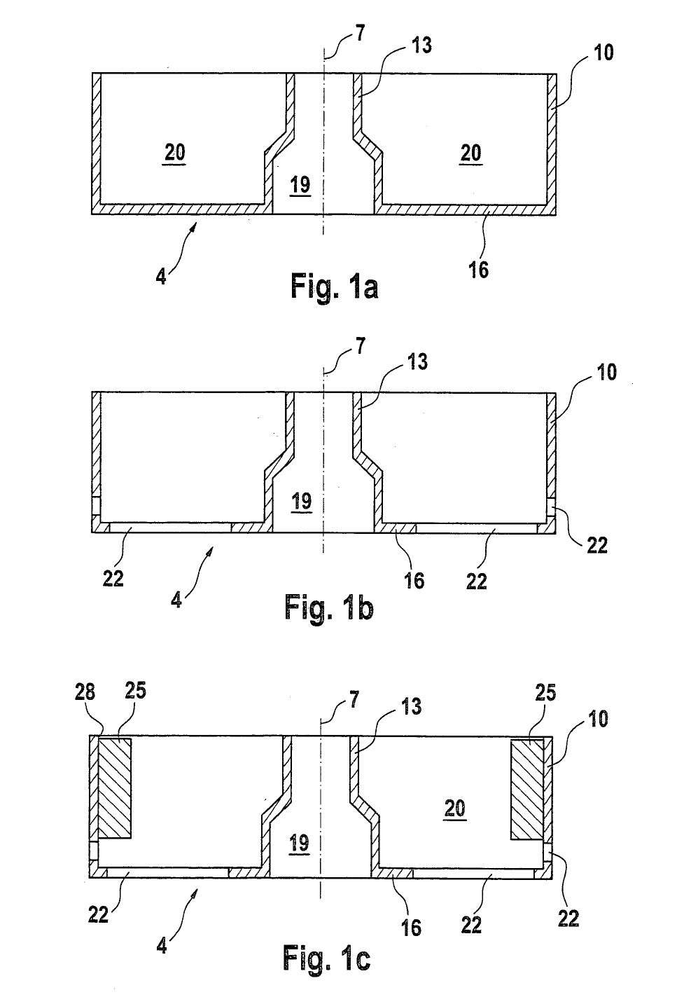

FIGS. 1a through 1c show initial steps for producing parts of an electrical machine 1 developed according to the invention, each of which is shown as an axial cross-section.

The electrical machine 1 is composed, at the least, of a housing 4 that functions, e.g., at least partially as a magnetic yoke, i.e., it is designed to be at least partially magnetically conductive.

The housing 4 comprises, for example, an outer wall 10 that is developed in the shape of a tube, for example, and an inner wall 13, which is also developed in the shape of a tube. The outer wall 10 is interconnected with the inner wall 13 by a base 16, i.e., they form a single-component housing 4, for example. The housing 4 has a central axis, and/or a symmetry axis 7.

The inner wall 13 borders an inner cavity 19 that is open at both axial ends, and the radial cross-section of which has the shape of a circle, but which can have various diameters along the central axis 7.

The housing 4 is open on the side opposite the base 16. The inner wall 13 and the outer wall 10 form an outer cavity 20 that is annular in shape, for example. The housing 4 is produced, for example, out of a tube or a piece of sheet metal by means of shaping.

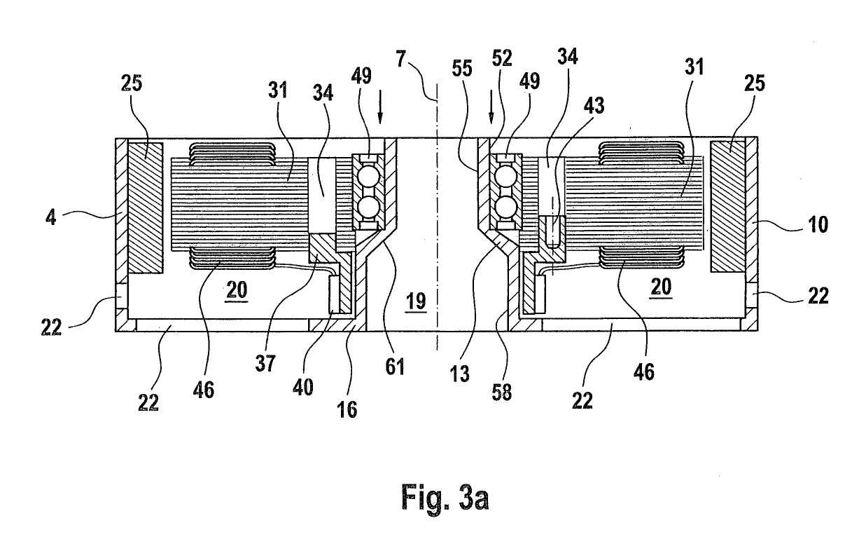

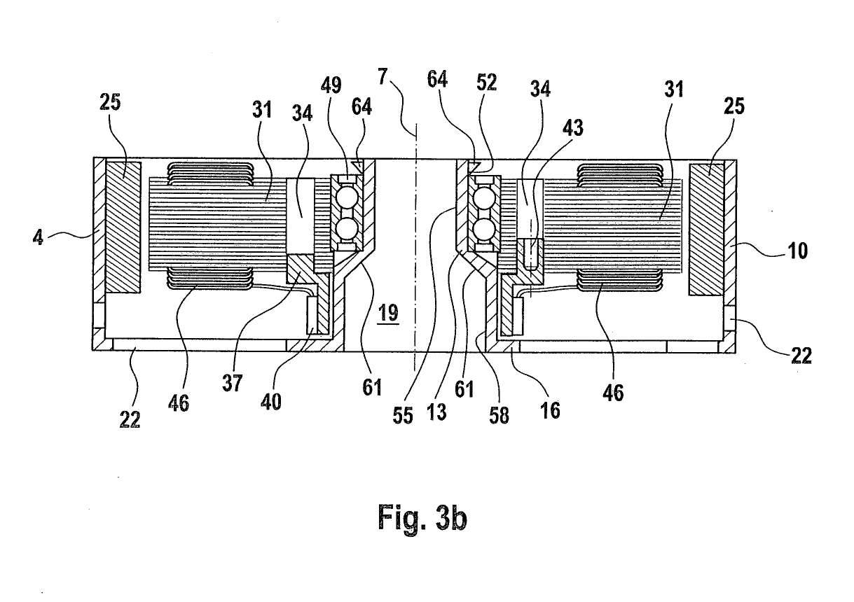

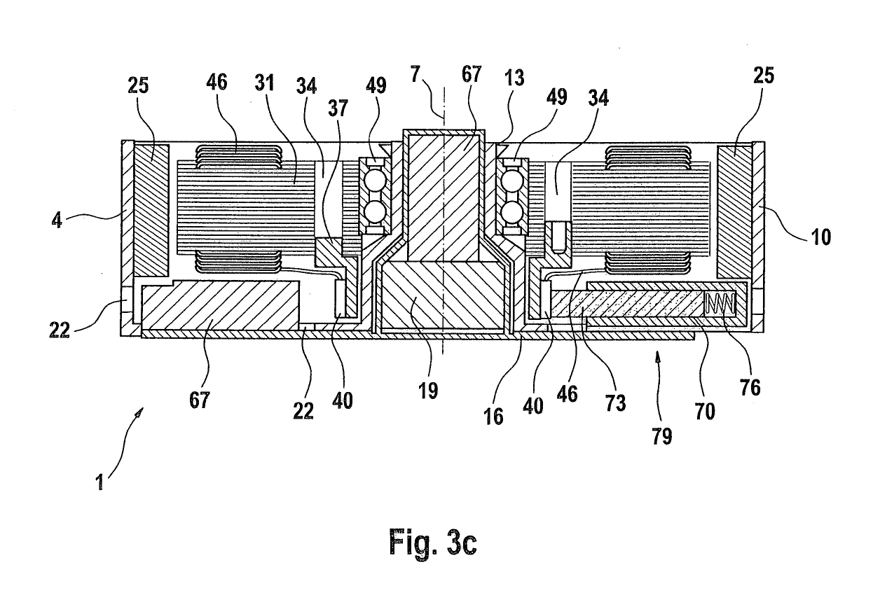

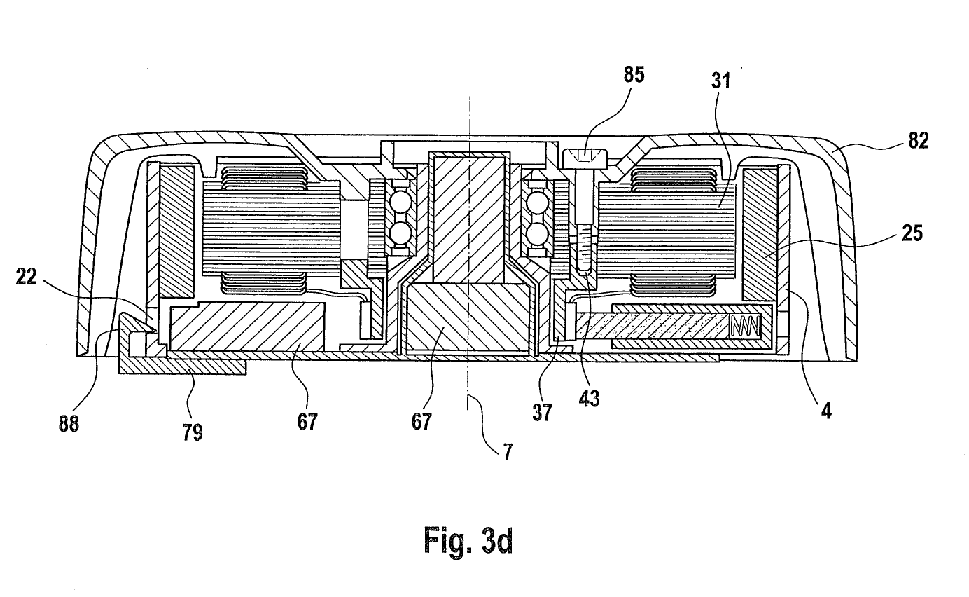

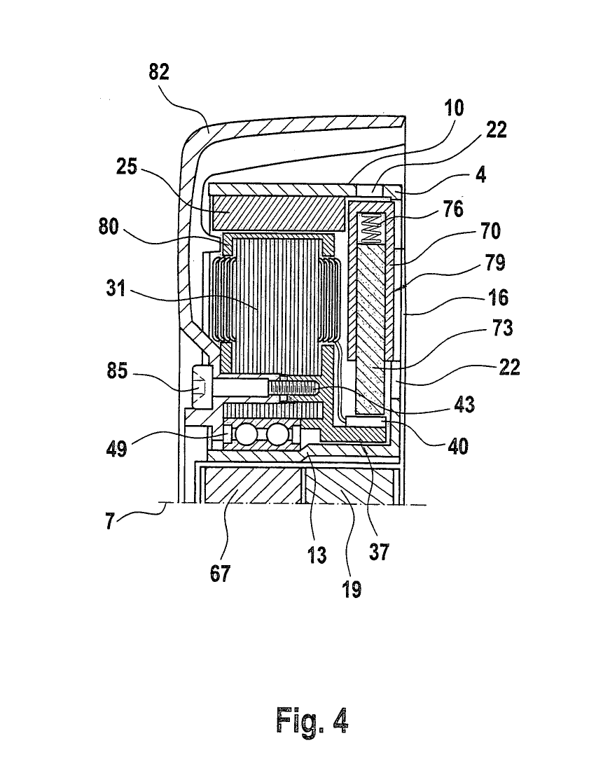

In the next production step (FIG. 1b), at least one recess 22 is created in the housing 4 and/or the outer wall 10 and/or the base 16. This recess 22 can already be present in the tube or sheet metal, however, that has been shaped into a housing 4 according to FIG. 1a. The recesses 22 serve to guide various elements into the housing 4, and/or to secure these elements to the housing 4 (FIGS. 3c, 3d).

At least one permanent magnet 25 is mounted on the inner wall 28 of the outer wall 10 of the housing 4, i.e., in the cavity 20 (FIG. 1c). It can be bonded to the inner wall 28. A further possibility for fastening the permanent magnets 25 in the housing 4 is to install springs—in known fashion—between each of the permanent magnets 25 in the radial circumferential direction, which said springs press the permanent magnets 25 tightly against the inner wall 28. The permanent magnets 25—together with the housing 4, which functions as magnetic yoke—form part of a magnetic circuit.

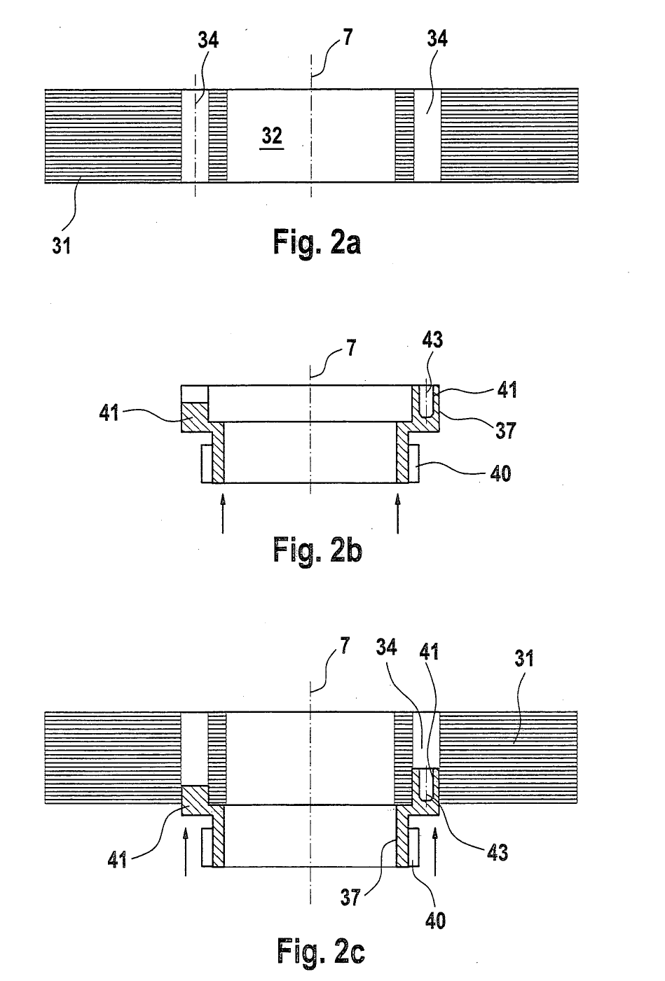

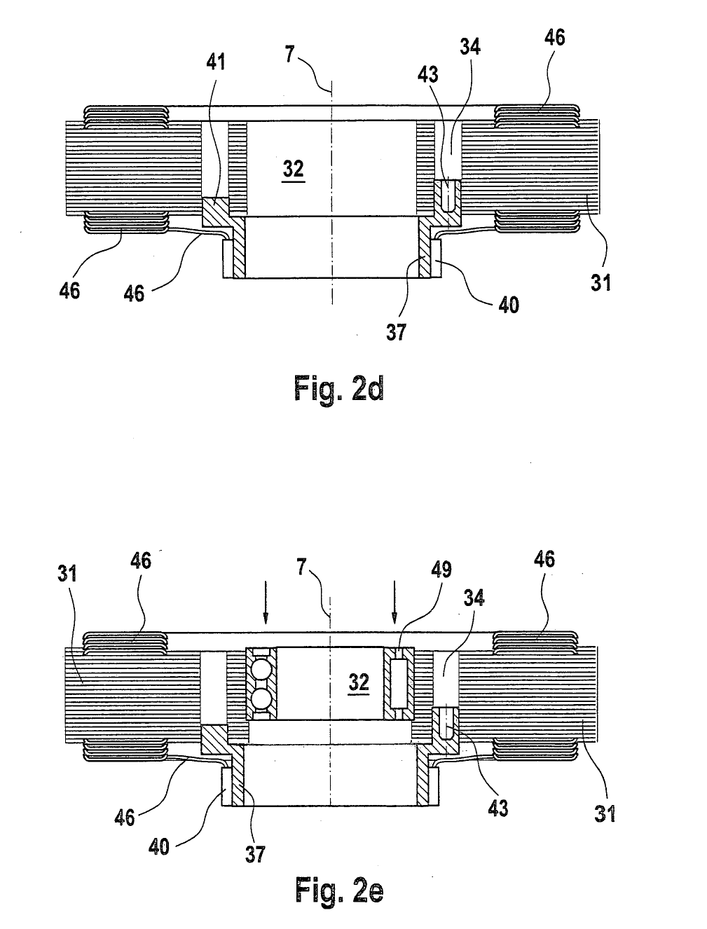

FIGS. 2a through 2e show steps for producing further parts of an electrical machine 1 developed according to the invention, each of which is shown as an axial cross-section.

FIG. 2a shows a laminated stack 31 that also has the central axis 7, for example, and, in addition to a central hole 32 around the central axis 7, comprises at least one hole 34 that extends continuously from the one axial end, parallel to the central axis 7, to the other axial end of the laminated stack 31.

FIG. 2b shows a commutator carrier 37 that is made of plastic, for example. The commutator carrier 37 also has the central axis 7 as symmetry axis. The commutator carrier 37 is developed in the shape of a tube, for example, and can comprise various inner and outer diameters along the central axis 7.

A commutator 40—composed, in known fashion, of a plurality of laminations having hooks composed of copper, for example—for an electrical commutator machine 1 is installed on the outer surface on an axial end of the commutator carrier 37. A fastening projection 41, for example, that serves to mount the commutator carrier 37 on the laminated stack 31 borders the part of the commutator carrier 37 with the commutator 40 (FIG. 2c).

A mounting hole 43, e.g., in the fastening projection 41 of the commutator carrier 37, is used to install a further component (FIG. 3d).

The commutator carrier 37 with the commutator 40 is pressed, for example, along with the fastening projection 41 into the hole 34 of the laminated stack 31, thereby mounting it on the laminated stack 31 (FIG. 2c). The commutator carrier 37 can also be bonded or screwed onto the laminated stack 31, for example.

After the commutator 40 has been mounted on the laminated stack 31 (FIG. 2c), an electrical winding 46 can be wound on the laminated stack 31 and, in known fashion, connected with the commutator in electrically conductive fashion 40 (FIG. 2d).

At least one bearing 49 is then installed and fixed on the laminated stack 31, e.g., by means of press fitting with the laminated stack 31 (FIG. 2e), by pressing it into the central hole 32 of the laminated stack 31, for example. The bearing 49 is a plain bearing or a rolling-element bearing, for example, in the form of a double ball bearing or a rolling element.

The arrangement according to FIG. 2e is now joined with the arrangement according to FIG. 1c (FIG. 3a).

The laminated stack 31 with the bearing 49 is now, e.g., completely situated in the housing 4, i.e., in the outer cavity 20. The bearing 49 bears against an outer wall 52 of the inner wall 13 in the outer cavity 20.

The inner wall 13 has, e.g., a first section 55 that comprises a first diameter, and a second section 58 that has a larger inner diameter compared with the first section 55. The first section 55 and the second section 58 are interconnected by means of an inclination 61, i.e., extending at an inclination relative to the central axis 7. The bearing 49 bears against the inclination 61 of the inner wall 13 with an axial end and is supported there.

In order to fix the bearing 49 at the housing 4 against the inner wall 13, it is calked on the other axial end, so that a calking 64 fixes the bearing 49 at the housing 4 (FIG. 3b). The bearing 49 can also be fixed at the housing by means of a circlip or a retainer or other fastening elements. A press fit of the bearing 49 against the inner wall 13 is also possible.

FIG. 3c shows one of the final steps to produce an electrical machine 1. Electronics 67, for example, such as a printed-circuit board, and/or electrical components, such as a capacitor, are installed in the inner cavity 19. At least one brush tube 70 with a brush 73, on the one hand, and further elements of the electronics 67, on the other hand, have been installed through the recesses 22 in the bottom 16 of the housing 4. The brush tubes 70 are mounted on a brush holder 79, for example, which at least partially accommodates the electronics 67 as well, so that the electronics and/or electrical components 67 can be installed in the housing 4 in one working step.

Further electrical elements, such as capacitors and interference-suppression chokes, for example, are fastened to the brush holder 79. The brush holder 79 can therefore be a carrier as well for all electronic and electrical elements 67 that is preassembled with these elements 67 and then mounted in the housing 4 in one fastening step.

A spring 76 in the brush tube 70 presses the brush 73 against the commutator 40.

The electrical machine 1 can be an electrical motor or an electrical generator.

FIG. 3d shows a possible application of an electric motor 1 as a fan. A single- or multiple-component fan wheel 82 is mounted on the laminated stack and/or in the mounting hole 43 by means of at least one screw 85.

The brush holder 79 is fixed by means of locking hooks 88, for example, that reach into a recess 22 of the housing 4 on the outer wall 10.

The electronics 67 control a current that flows through the brushes 73, through the commutator 40, and through the winding 46, the electric motor 1. The fan wheel 82 turns as a result of the magnetic forces that are present between the laminated stack 31 and the permanent magnets 25.

FIG. 4 is a subsection of an axial cross-section of a further exemplary embodiment of an electrical machine 1 developed according to the invention. The laminated stack 31 and/or the winding 46 are at least partially enclosed by a non-electrically conductive jacket 80 that has been manufactured, for example, by applying a plastic coating by injection molding or by dipping in a curable adhesive. When this plastic coating is applied by injection molding, the commutator carrier 37 with the mounting hole 43 on or in the laminated stack 31 can be produced at the same time.

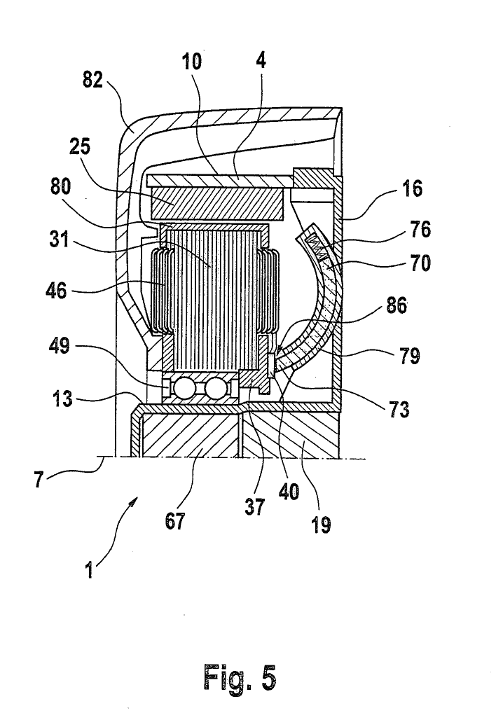

FIG. 5 is a subsection of an axial cross-section of a further exemplary embodiment of an electrical machine 1 developed according to the invention. The commutator 40 is developed as a planar commutator, for example, i.e., an area of contact 86 of the commutator 40 with the brush 73 is positioned, e.g., at a right angle to the central axis 7, or it definitely forms an angle of intersection with the central axis 7 that is not equal to zero. The brush tube 70 and, therefore, the brush 73 as well, are developed bent in shape, for example, in order to shorten the axial size of the electrical machine 1 in the direction of the central axis 7. The radius of the bent brush 73 extends in the plane of the drawing. If the axial extension of the electrical machine 1 plays a less important role, then straight brushes 73 can be used that only extend in the axial direction 7.

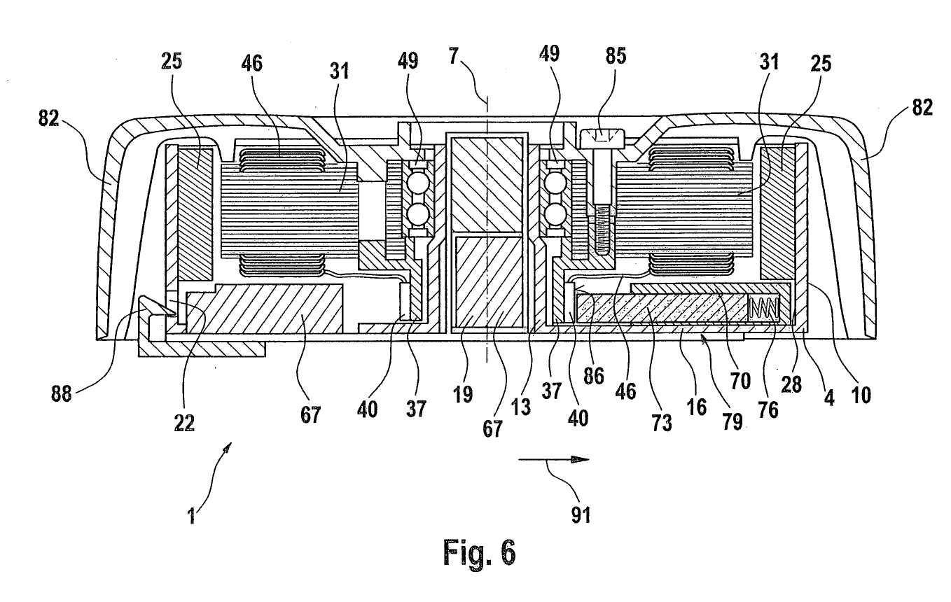

FIG. 6 illustrates how the diameter of the commutator 40 of an electrical machine 1 developed according to the invention—and shown as an axial cross-section—can be varied.

The commutator carrier 37 with the commutator 40 is developed so that the commutator 40 is located as close to the inner wall 13 of the housing 4 as possible. As a result, there is a large space between the area of contact 86 of the commutator 40 and the inner wall 28 of the outer wall 10 of the housing 4 in the radial direction 91, at a right angle to the central axis 7, so that the carbon brush can be designed particularly long.

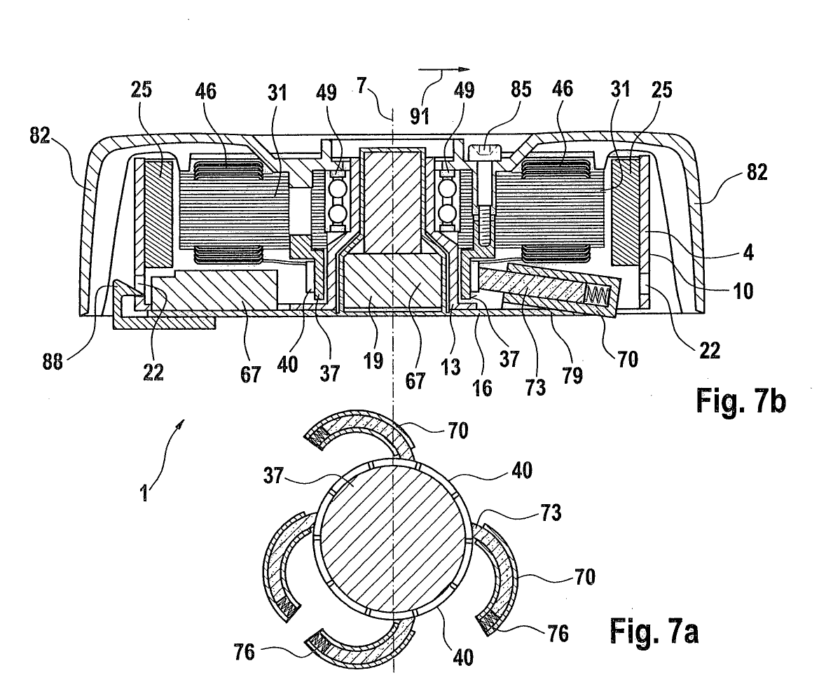

FIG. 7a is an axial top view of the commutator carrier 37 with the commutator of an electrical machine 1 developed according to the invention.

The brush tube 70 and the brush 73 are bent in the plane of the drawing in FIG. 7a, i.e., they are bent around the central axis 7 in the installed state (FIG. 7b) in the electrical machine 1.

FIG. 7b also shows that the brush tube 70 and/or the brush holder 79 is positioned at an angle to the central axis 7, so that the brush 73 guided through the brush tube 70 bears against the commutator 40 at an angle. This results is a larger area of contact 86 between the commutator 40 and brush 73, which improves the run-in behavior and/or the noise emission.

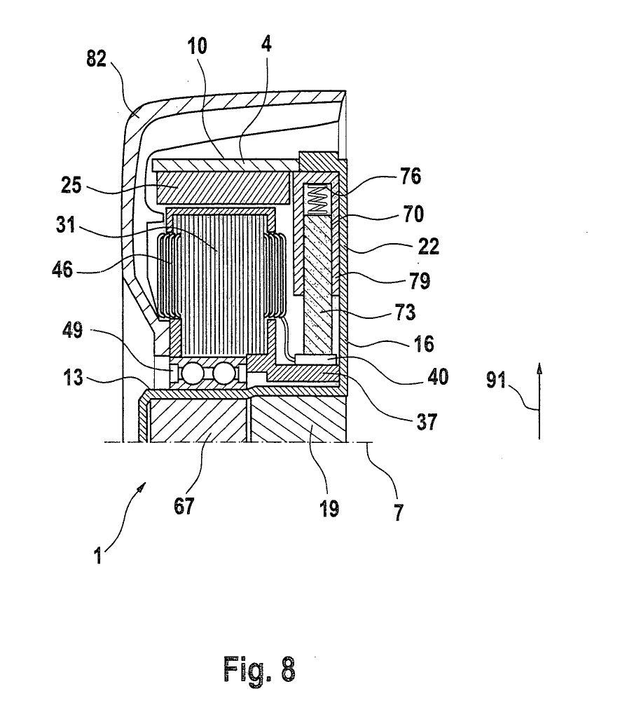

FIG. 8 is a subsection of an axial cross-section of a further exemplary embodiment of an electrical machine 1 developed according to the invention, in the case of which at least part of the housing 4 is composed of plastic.

The housing 4 is composed of the outer wall 10, e.g., a pole tube that forms the magnetic yoke for the electrical machine 1. The outer wall 10 is a simple metal tube, for example.

The base 16 and the inner wall 13 are integrally extruded onto the outer wall 10, for example, or they are installed as a separate component with the function of the brush holder 79.

The bearing 49 is therefore located and fixed between the laminated stack 31 and the inner wall 13 composed of plastic. The brush tube 70 and/or the brush holder 79 are developed, e.g., as a single component, on the base 16. The inner wall 13 can therefore be produced simultaneously with production of the brush holder 79 without increasing the number of parts to be installed.

The pole tube 10 can also be composed at least partially of a mixture of plastic and a magnetically excitable material.

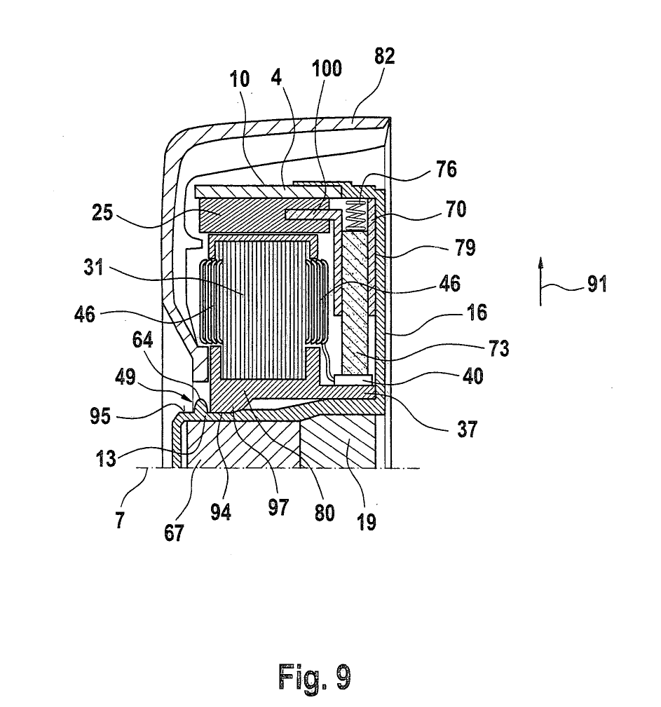

FIG. 9 is a subsection of an axial cross-section of a further exemplary embodiment of an electrical machine 1 developed according to the invention. The inner wall 13 of the housing 4 is composed of plastic, for example, but it can also be designed as a single component composed of metal as shown in FIG. 1a. The bearing 49 is formed by a sliding surface 94 that is developed on an outer wall 95 of the inner wall 13. The laminated stack 31 comprises a jacket 80, e.g., a plastic coating applied by injection molding, i.e., a part of the coating applied by injection molding 80, e.g., in the form of a projection 97, extends in the sliding surface 94. The sliding surface 94 is formed, for example, by a radially full-perimeter low spot in the outer wall 95, or by calkings 64 of the inner wall 13 on the outer wall 95.

The magnets 25 can be fixed to the outer wall 10 not only by means of bonding or spring action, they can also be fixed by means of a magnet mount 100 that is developed on the brush holder 79 and extends in the axial direction 7 into the magnets 25. It is also possible to have applied a plastic coating to the magnets by injection molding during production of the brush holder 79 or a carrier for the electrical-electronic component 67, by way of which they are also fixed on the brush holder 79 or the carrier. The magnets 25 are then installed when the brush holder 79 and/or the electrical-electronic component 67 are installed.

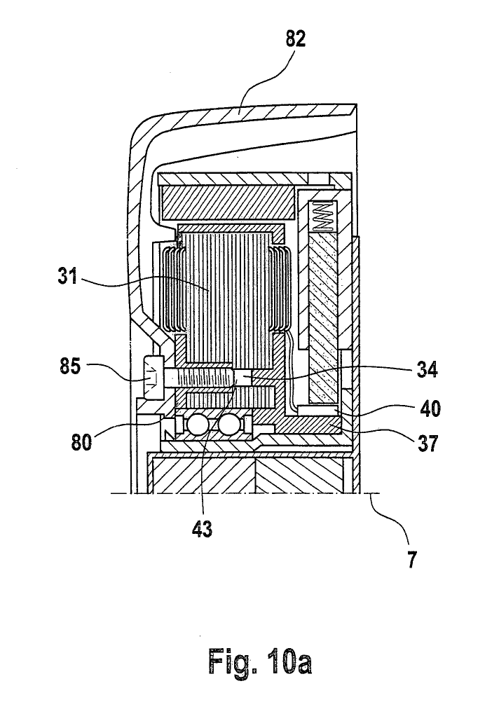

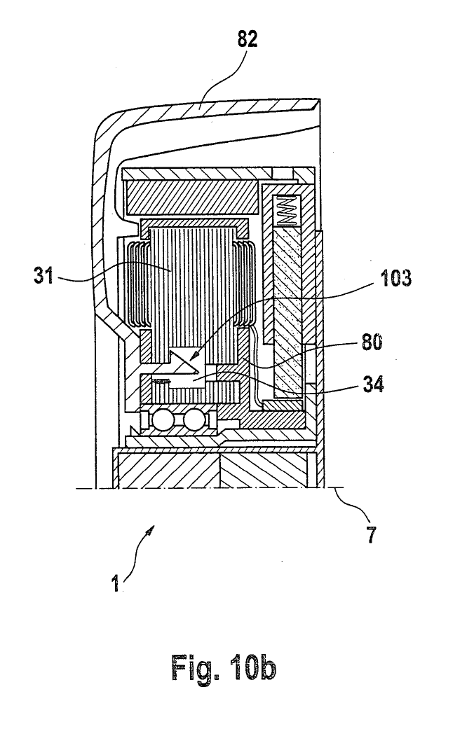

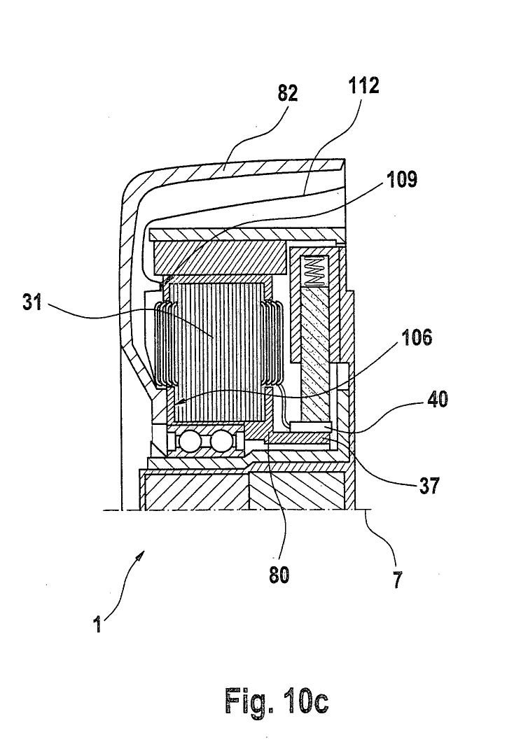

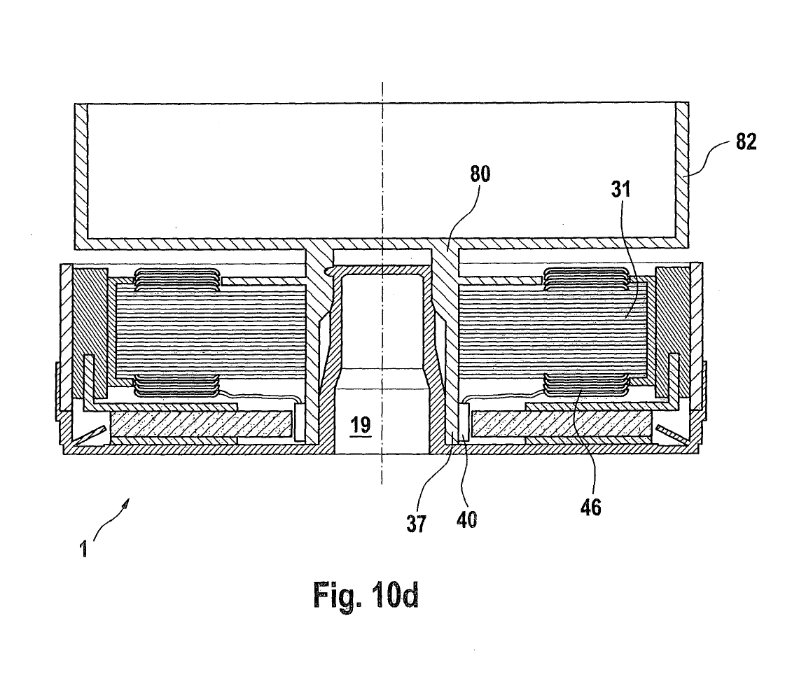

Various possibilities for fixing the fan wheel 82 to the laminated stack 31 of the electrical machine 1—shown as a subsection of an axial cross-section-are shown in FIGS. 10a through 10d.

One possibility for fixing the fan wheel 82 to the rotating laminated stack 31 is to thread a screw 85 into a mounting hole 43 of the laminated stack 31, whereby the fan wheel 82 is tightly connected between a screw head of the screw 85 and the jacket 80 of the laminated stack 31. The mounting hole 43 can also be formed by a separate commutator carrier 37 or by the injection molding-applied coating 80 of the laminated stack 31.

The laminated stack 31 with the winding 46, the jacket 80, the commutator 40 and the fan wheel 82 are parts of the rotor of the electrical machine 1.

The housing 4 with the magnets 25, the brush tubes 70 and the electrical-electronic component 67 are parts of the stator of the electrical machine 1.

It is also possible for the fan wheel 82 to comprise a locking hook 103 that reaches into the hole 34 of the laminated stack 31 and snaps in place behind an undercut of the hole 34 (FIG. 10b), by way of which the fan wheel 82 is fixed to the laminated stack 31.

The fan wheel 82 can also be welded or bonded with the laminated stack 31 or the jacket 80 of the laminated stack 31. The fan wheel 82 can be composed of metal or plastic.

The fan wheel 82 comprises, e.g., a fan wheel coating 112 on its inner side, on which, e.g., a support foot 109 that extends in the axial direction 7 is formed. The support foot 109 bears against the jacket 80 of the laminated stack 31. The support foot 109 can also be welded or bonded with the jacket 80 at 106 (FIG. 10c). The fan wheel 82 can also comprise two support points in the radial direction 91 on the jacket 80 or the laminated stack 31.

The fan wheel 82 can also be produced simultaneously with the production of the jacket 80 of the laminated stack 31, e.g., by means of injection molding of plastic (FIG. 10d). The fan wheel 82 forms a radial fan, for example.

In place of the fan wheel 82, a tooth system in the form of a worm, a spur gear or a bevel gear can be produced with the jacket 80 of the laminated stack 31, if the electrical motor 1 is used as a servomotor.

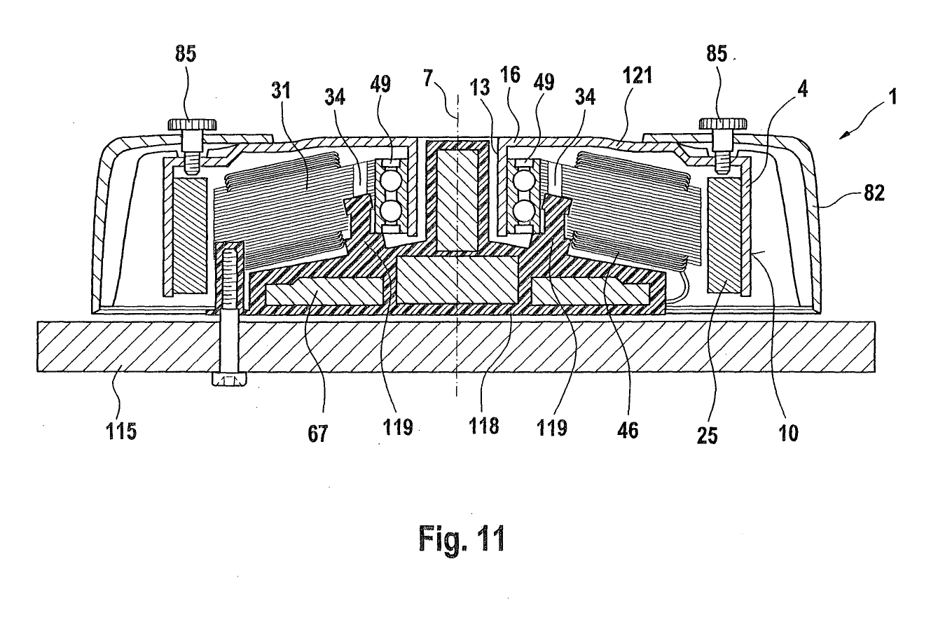

FIG. 11 is an axial cross-section of an electrical machine 1 developed according to the invention, which said electrical machine is developed as a brushless electrical machine 1. The design of a brushless electrical machine 1 having a laminated stack 31 located in the interior differs from the design of a commutator machine 1 (FIG. 3c) in that, for example, the electrical machine 1 is designed as an outer rotor.

The electrical-electronic component 67 with its carrier 118 is fixed to the laminated stack 31, e.g., in the hole 34, by means of a peg 119 with an undercut. Additionally, the electrical-electronic component 67 is not mounted on the housing 4, but on a fan holder 115 that is permanently located in a motor vehicle, for example. The laminated stack 31 with the winding 46 and the electrical-electronic component 67 form the stator of the electrical machine 1.

The bearing 49 is also fixed between the laminated stack 31 and the housing 4.

The base 16 of the housing 4 is formed on a side furthest from the electrical-electronic component 67. The housing 4 rotates accordingly, so that the, e.g., separately formed fan wheel 82 is fixed to the housing 4 and not the laminated stack 31. The fan wheel 82 can also be formed as an integral part of the housing 4.

The rotor is formed by the housing 4 with the magnets 25.

Laminations of the laminated stack 31 can also extend at an angle to the central axis 7, in order to make optimal use of the space in the housing 4.

A magnetic alternating field is produced in the laminated stack/winding component by applying, e.g., an alternating current to the winding 46, or a current is controlled by closed-loop control electronics, which said current interacts with the magnetic field of the permanent magnets 25.

FIG. 12 shows, in axial cross-section, a further variant of the arrangement of the bearing 49 at the housing 4 and laminated stack 31 for an electrical machine 1 developed according to the invention.

The housing 4 is composed only of an outer wall 10, which is designed as a pole tube, for example. With the permanent magnets 25, the housing 4 forms the stator. The rotor is formed by the laminated stack 31 with a winding 46. A bearing is located between the outer wall 10 and the laminated stack 31 at both axial ends of the laminated stack 31.

On one axial end, the brush tube 70 with the brush 73 and/or the brush holder 79 are situated so that the brush 73 touches the commutator 40, which said commutator is interconnected with the laminated stack 31 via the commutator carrier 37, for example.

The winding 46 is located on the laminated stack 31 in the axial direction 7 only where the permanent magnets 25 also extend.

A rotor shaft is not required for the electrical machine 1 with this arrangement, either. The control electronics 67 can be located at an axial end of the housing 4. Likewise, a fan wheel 82 can be mounted on the laminated stack 31 at the axial end of the laminated stack 31 opposite the commutator 40.

The stator can also be composed of the housing 4—developed as a pole tube—and a second winding at the housing 4, i.e., the permanent magnets 25 are replaced by a winding in this embodiment.

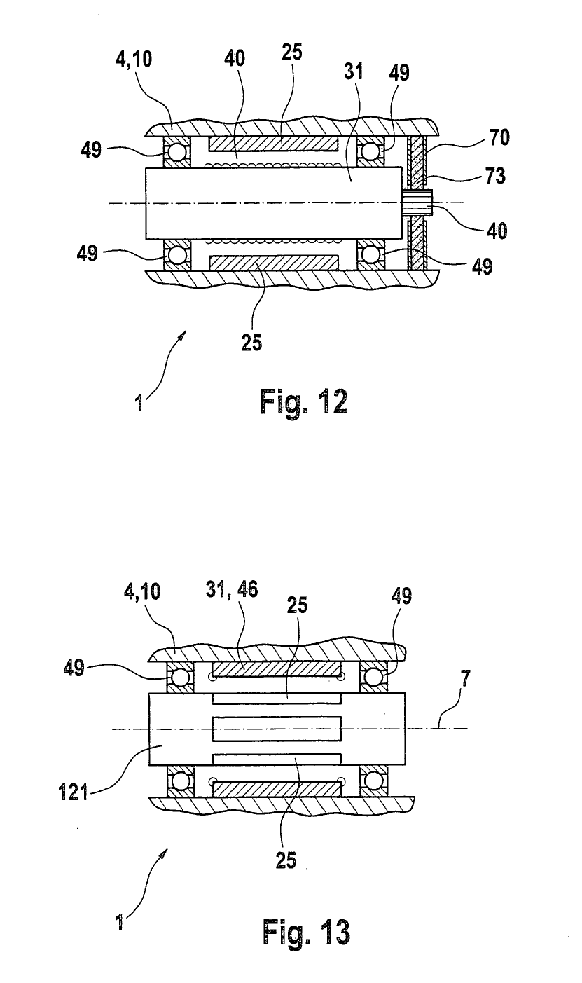

FIG. 13 shows, in axial cross-section and based on FIG. 12, a brushless variant of the arrangement of housing 4 and bearing 49 for an electrical machine 1 developed according to the invention.

The rotor is composed of a basic structure 121, which is composed of plastic, for example. At least one permanent magnet 25, for example, is located in the basic structure 121, which said permanent magnet comprises a coating of plastic, for example, applied by injection molding. The basic structure 121 can also be partially composed of a mixture of plastic and a magnetically excitable material that has been magnetized accordingly. A laminated stack 31 is located at the housing 4 and/or the pole tube 10, in which said laminated stack a winding 46 is located and thereby forms the stator.

The electrical alternating current that flows through the winding 46 produces a magnetic alternating field that causes the basic structure 121 with its magnetic poles to rotate.

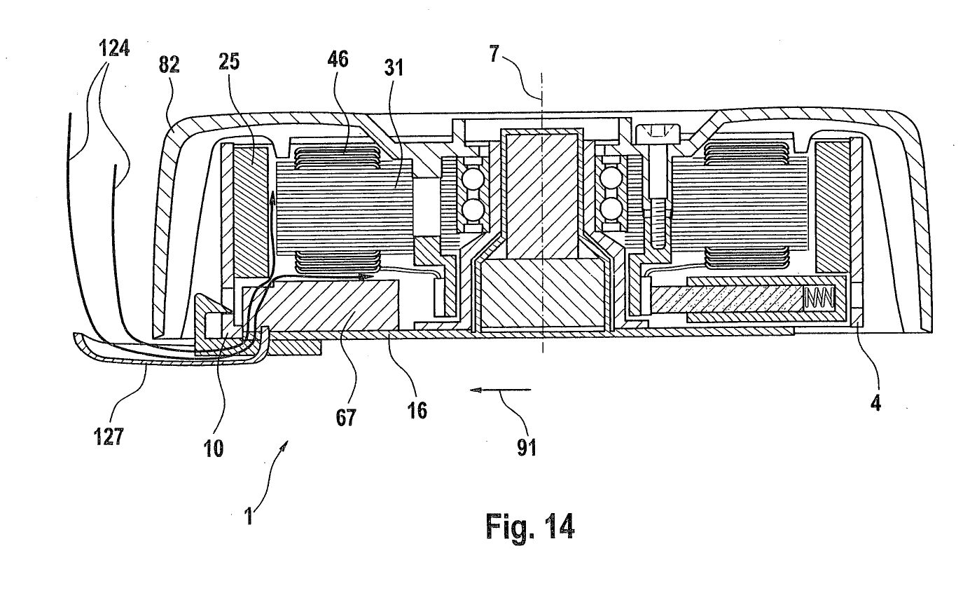

FIG. 14 shows, in axial cross-section, an electrical machine 1 developed according to the invention and that is developed as a fan.

While the electrical machine 1 is operating, ohmic losses cause the winding 46 and/or the laminated stack 31 to heat up, which said heat can be dissipated by flowing air.

The fan wheel 82 is mounted on an axial end of the laminated stack 31 and extends from there first in the radial direction 91, and then extends in the axial direction 7 along the outer wall 10.

Air is drawn in, for example, by means of a routing sheet 127 that is bent toward the fan wheel 82, that is located at the housing 4 of an electrical machine 1 according to FIG. 3d, e.g., at the base 16 or at the housing 4, and that projects over the fan wheel 82 in the radial direction 91, which said air flows through appropriate openings past the closed-loop control electronics 67 and the air gap between the magnet 25 and the laminated stack 31, by way of which they are cooled.

The routing sheet 127 does not necessarily have to be composed of sheet metal, of course. It can also be composed of plastic.

What is claimed is:

1. An electrical machine
that comprises, at the least:
at least one housing,
at least one laminated stack,
a stator and a rotor, between which at least one bearing is situated,
wherein
at least part of the at least one bearing (49) is fixed between the laminated stack (31) and the housing (4, 10, 13).

2. An electrical machine
that comprises, at the least:
at least one basic structure that comprises magnetic poles, at least in parts,
a stator and a rotor, between which at least one bearing is situated,
wherein
at least part of the at least one bearing (49) is fixed between the basic structure (121) and the housing (4, 10, 13).

3. The electrical machine according to claim 2,
wherein
the basic structure (121) comprises at least one permanent magnet (25).

4. The electrical machine according to claim 2 or 3,
wherein
at least part of the basic structure (121) is composed of plastic.

5. The electrical machine according to claim 4,
wherein
at least part of the basic structure (121) is composed of a mixture of plastic and a magnetically excitable material.

6. The electrical machine according to claim 1 or 2,
wherein
the housing (4) is composed of an outer wall (10) and an inner wall (13) that are interconnected by a base (16)

7. The electrical machine according to claim 1,
wherein
a commutator (40) of an electrical commutator machine (1) rotates with the laminated stack (31).

8. The electrical machine according to claim 1 or 7,
wherein
the commutator (40) is situated on a commutator carrier (37) that is mounted on the laminated stack (31).

9. The electrical machine according to claim 1 or 2,
wherein
the bearing (49) is fixed at the housing (4, 10, 13) by at least one calking (64).

10. The electrical machine according to claim 1, 2 or 6,
wherein
at least one electronic-electrical component (67) is fixed at the housing (4, 10, 13).

11. The electrical machine according to claim 10,
wherein
the electronic-electrical component (67) comprises at least one brush tube (70).

12. The electrical machine according to claim 10 or 11,
wherein
the electrical-electronic component (67) comprises closed-loop control electronics for the electrical machine (1).

13. The electrical machine according to claim 1 or 2,
wherein
a fan wheel (82) is mounted on the laminated stack (31).

14. The electrical machine according to claim 2 or 4,
wherein
a fan wheel (82) is mounted on the basic structure (121).

15. The electrical machine according to claim 1 or 11,
wherein
the electrical machine (1) comprises at least one brush tube (70), and
wherein
the brush tube (70) comprises electrically conductive brushes (73) that are bent.

16. The electrical machine according to claim 1 or 13,
wherein
the laminated stack (31) comprises a jacket (80) composed of plastic.

17. The electrical machine according to claim 1 or 2,
wherein
the housing (4) is formed by a pole tube (10) and a housing part (13) composed of plastic, and
wherein
part of the bearing (49) is fixed at the housing part (13) composed of plastic.

18. The electrical machine according to claim 7 or 8,
wherein
the commutator (40) is a planar commutator.

19. The electrical machine according to claim 1,
wherein
the electrical machine (1) comprises at least one permanent magnet (25) located in the vicinity of the housing (10), and a brush holder (79), and
wherein
the permanent magnet (25) is secured to the brush holder (79).

20. The electrical machine according to claim 1, 2 or 17,
wherein
the bearing (49) is formed by a plastic bearing.

21. The electrical machine according to claim 20,
wherein
the plastic bearing (49) is an integral part of a housing part (13) composed of plastic.

22. The electrical machine according to claim 1 or 16,
wherein
a brush holder (79) is an integral part of a jacket (80) of the laminated stack (31).

23. The electrical machine according to claim 1 or 2,
wherein
the electrical machine (1) is a brushless electrical machine.

24. The electrical machine according to claim 1,
wherein
the electrical machine (1) is an electrical commutator machine.

25. The electrical machine according to claim 1 or 2,
wherein
at least part of the housing (4, 10) forms a magnetic yoke.

26. The electrical machine according to claim 1 or 16,
wherein
a tooth system is fixed on the laminated stack (31).

27. The electrical machine according to claim 2 or 4,
wherein
a tooth system is fixed on the basic structure (121).

28. The electrical machine according to claim 16,
wherein
the jacket (80) is produced by means of injection molding of plastic.

29. The electrical machine according to claim 17,
wherein
the electrical machine (1) comprises a brush holder (79), and
wherein
the housing (4) is formed by a pole tube (10) and a housing part (13) that is located on the brush holder (79), and
wherein
part of the bearing (49) is fixed at the brush holder (79).

30. The electrical machine according to claim 17,
wherein
at least part of the pole tube (10) is composed of a mixture of plastic and a magnetically excitable material.
